(19) United States
(12) Patent Application Publication
(10) Pub. No.: US 2002/0129036 A1
(43) Pub. Date: Sep. 12, 2002

(54) System and method for storing and manipulating multi-media

(75) Inventors: Kenneth Ho Yuen Lok, Singapore (SG); Kuan Yeh Cheang, Singapore (SG); Sebastian Lim Kim Seng, Singapore (SG)

Correspondence Address: David L. McCombs, Hayes and Boone LLP, Suite 3100, 901 Main Street, Dallas, TX, 75202-3789, US

(73) Assignee: TeraOptix, Inc., Carrollton, TX (US)

(21) Appl. No.: 09/755,940

(22) Filed: Jan. 5, 2001

(51) Int. Cl. G06F 7/00

(52) U.S. Cl. 707/104.1

(57) ABSTRACT

A method and system for providing access to and management of multimedia files on a plurality of storage devices is described. The method can include: storing a plurality of multimedia files on at least one of the plurality of storage devices; providing access for a user to the plurality of multimedia files; means for encoding and decoding compressed multimedia files; and means for playing the plurality of multimedia files.

### BACKGROUND OF THE INVENTION

The invention relates generally to computers and, more particularly, to a method and apparatus to store multi-media online.

Towards the end of the last millennium, four technologies were maturing and converging in the Home consumer electronics arena. The Compact Disc (CD) technology, which has enjoyed widespread adoption in both consumer and Personal Computer (PC) applications, has matured to enable recording on the popular optical media, especially for the ReWritable CD (CD-RW) Media. Consumer CD Recorders using the CD-RW media enabled consumers for the first time to compile and record onto the CD media high quality music of their choice. On another front, audio compression techniques has improved greatly to allow for high compression ratios of more than 1-10, and yet retain almost CD-like music quality to the human ears. With the proliferation of the Internet, one particular format, MPEG, Audio layer 3 (MP3), gained popularity as the compression of choice for transmission of audio files over the Internet. The MP3 format is also desired for storing of these files in many different storage media like Hard Disk Drives (HDD), Flash cards and CDs. Separately, the HDD industry serving the PC market, has continued their march towards higher capacity on the magnetic media at the same or lower cost. To date, HDD of 20 GB are available at US$150, giving approximately, US$0.0075 per MB of random access memory, the lowest among all competing random access storage media. Lastly, the propagation of the use of Internet in multiple applications has brought about a paradigm shift in the way we can manage and share information. Used in a proper manner, the Internet can change the way music can be distributed, managed and share in ways that was never possible before.

What is needed is a system and method that brings these four technology advances together in a consumer box to enhance the home entertainment experience.

### SUMMARY OF THE INVENTION

In contrast to the prior art, the present invention provides a method that allows consumers to digitally consolidate and archive their personal multimedia library into a single easily accessible storage, that can be expanded as their multimedia collection grows. Users are able to compile, program and play their multimedia to suit the mood and occasion. Users can remotely manage their libraries to pre-program, group, rank and sort according to their fancies. Additionally, an Internet connection and thus, Internet music distribution, means that consumers can now buy and add to their multimedia collection right in their living room. Moreover, users are able to write onto a CD their favorite tracks to bring along with them for portable use.

One embodiment of the system operates in conjunction with existing Home Theater equipment and presumes a fast connection (e.g. a 10/100baseT connection) to the Internet. However, many other embodiments are contemplated.

Therefore, in accordance with the previous summary, objects, features and advantages of the present invention will become apparent to one skilled in the art from the subsequent description and the appended claims taken in conjunction with the accompanying drawings.

### BRIEF DESCRIPTION OF THE DRAWINGS

FIG. 1 illustrates a general architecture of an embodiment of the present invention;

FIGS. 2A and 2B illustrate a more detailed architecture of the iJB;

FIG. 3 is a flowchart of an implementation of recording from CD-DA;

FIG. 4 is a flowchart of an implementation of recording from MP3 CD;

FIG. 5 is a flowchart of an implementation of recording from a line-in;

FIG. 6 is a flowchart of an implementation of editing playlists;

FIG. 7 is a flowchart of an implementation of playback of media files;

FIGS. 8-10 depict example recording procedures;

FIGS. 11-12 depict example playback procedures;

FIGS. 13-15 depict example download procedures;

FIG. 16 illustrates an implementation of a display attached to the iJB; and

FIGS. 17-18 depict more example procedures of the present invention.

### DETAILED DESCRIPTION OF THE PREFERRED EMBODIMENTS

The present invention can be described with several examples given below. It is understood, however, that the examples below are not necessarily limitations to the present invention, but are used to describe typical embodiments of operation.

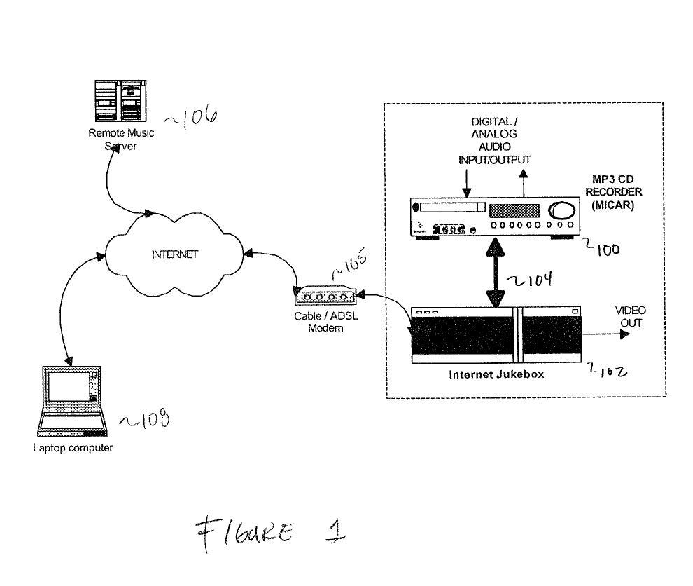

One embodiment of the present invention is illustrated in FIG. 1 and consists of 2 separate modules: a CD Recorder 100 and an Internet Jukebox 102. These 2 boxes are linked by a high speed data bus 104. In this embodiment, the Internet Jukebox 102 connects to the Internet through a broadband cable modem or an ADSL modem 105. Typically this is achieved using a 10/100baseT connection. The MP3 CD Recorder 100 is a standalone device that can operate without the Internet Jukebox 102. As part of the service, a remote Music server 106 provides remote access to the Jukebox from any terminal 108 linked to the Internet. This enables the user to remotely manage and browse the content of the Jukebox 102 online. The Music Server 106 can also provide other commercial services like streaming audio programs, CD-on-demand music distribution, CD database (CDDB) synchronization with the Jukebox 102, etc.

With the advent of the digital age, more and more entertainment content is appearing in digital form (e.g. digital audio in compressed and non-compressed forms, digital video and digital photos). These contents are mainly recorded and distributed in CD, Laser Disc (LD), Digital Video Disc (DVD) and flash memory media. All these media, with their respective merits, still do not provide the convenience of a centralized home storage with mechanisms for instant browsing, sorting, searching, archiving, compiling and recalling for instantaneous playback.

The Internet Jukebox (iJB) 102 provides these conveniences for all forms of home entertainment related contents. In addition to the pure storage function, the iJB 102 provides additional unique functions that make the iJB 102 ideally suited for the home consumer space. These are:

Expandable to external storage array configurations (e.g., Storex arrays, described later in the text); this allows for continuous storage expansion and eliminates the possibility of data obsolesce or storage space constraints;

The iJB can also be connected to the CD Recorder, via a USB interface, to download and write the contents onto convenient CD media in the various audio and video formats;

With RJ45-Ethernet connectivity, the iJB allows remote management of content residing on the iJB; the iJB also connects to the music server via the same Ethernet port and utilizing a home broadband Internet gateway;

Audio playback of MP3 content; upgradable to support other file formats;

Digital photo display and slide shows to TV; and

Playback of video contents from the Hard disk to TV.

Details of iJB 102 Architecture

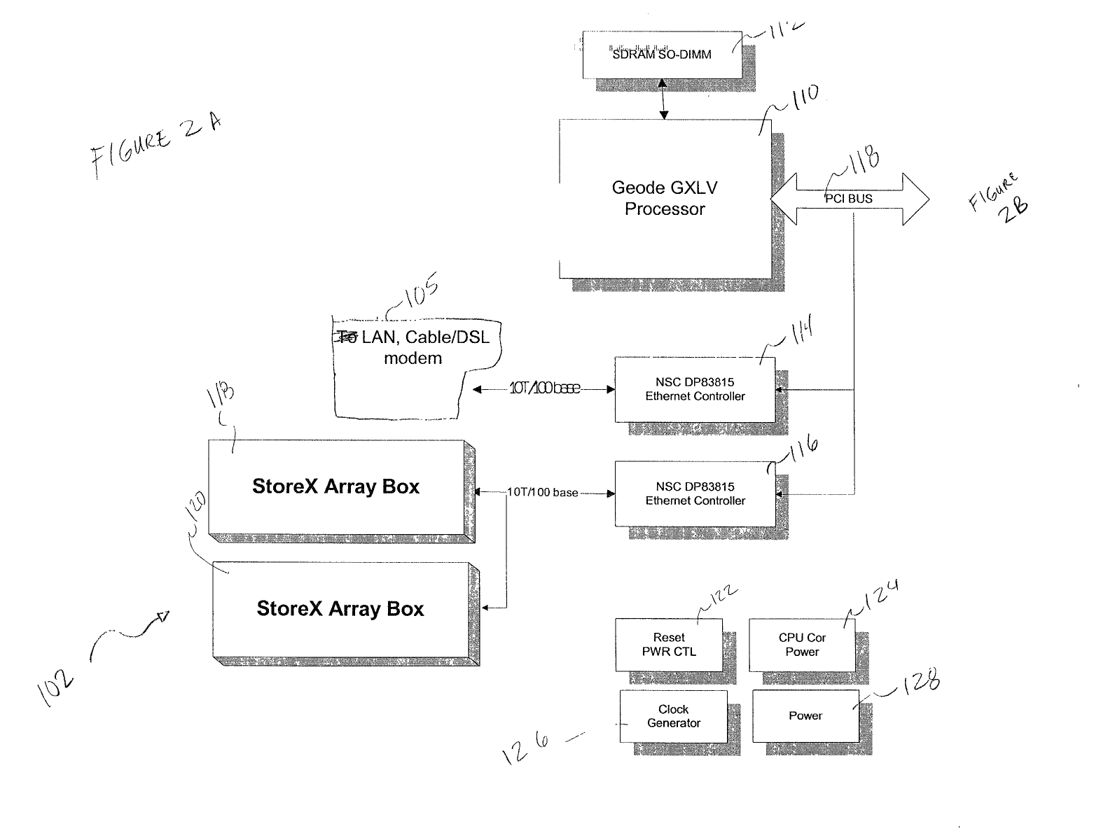

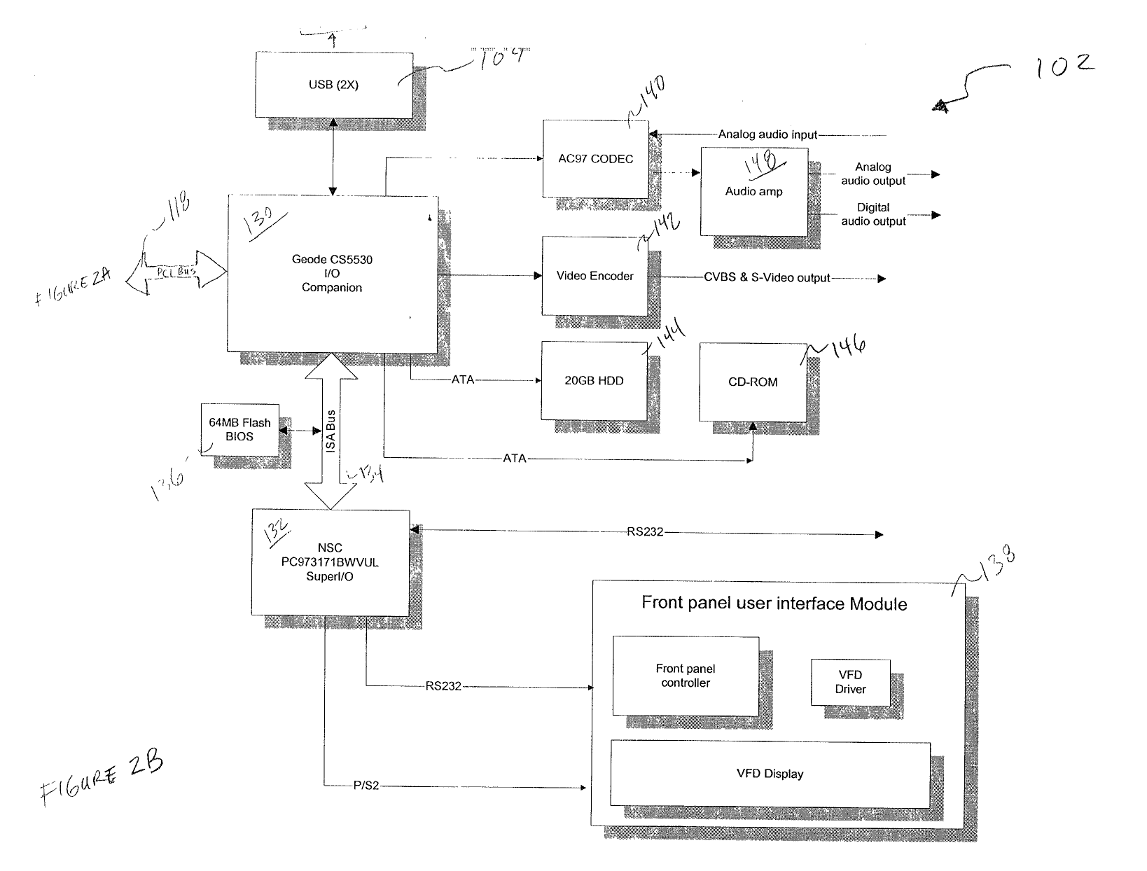

Now referring to FIGS. 2A and 2B, more details of an exemplary architecture for the iJB 102 is shown. In this embodiment, a Geode GXLV processor 110 with a SDRAM SO-DIMM memory 112 and two NSC DP838815 Ethernet controllers are connected by a PCI Bus 118. The first Ethernet controller 114 connects to a LAN or a CABLE/DSL modem 105 through a 10T/100 base connection for example, to connect the iJB 102 to the Internet (as also shown in FIG. 1). The second Ethernet controller 116 connects to a pair of StoreX Array Boxes 118 and 120 for storage of the files within the iJB 102. The StoreX Array Box is described in more detail below within the text. FIG. 2A also illustrates modules for reset PWR CTL 122, CPU Cor Power 124, Clock Generator 126, and Power 128 as part of the architecture of the iJB 102.

FIG. 2B is connected to FIG. 2A by the PCI Bus 118 and includes a Geode CS5530 I/O companion 130 connected to the PCI Bus 118. Also depicted is the USB (2X) bus 104 that connects the iJB 102 to the CD recorder 100 (depicted in FIG. 1). Additionally, a NSC PC97317BWVUL SuperI/O module 132 is connected to the Geode Companion 130 through an ISA Bus 134 with a 64 MB Flash BIOS module 136. Moreover, the diagram shows a Front Panel user Interface Module 138 connected to the NSC SuperI/O module 132 through an RS232 connection as well as a P/S2 connection. The Front Panel Module 138 includes a front panel controller, and VFD driver and a VFD display.

Furthermore, the Geode Companion 130 is connected to an AC97 CODEC 140, a Video Encoder 142, a 20 GB HDD 144 and a CD-ROM 146. In turn, the CODEC 140 is connected to an Audio AMP 148 with analog and digital audio outputs and also has another analog audio input. Additionally, the Video Encoder 142 has a CVBS and S-Video output.

1. Recording

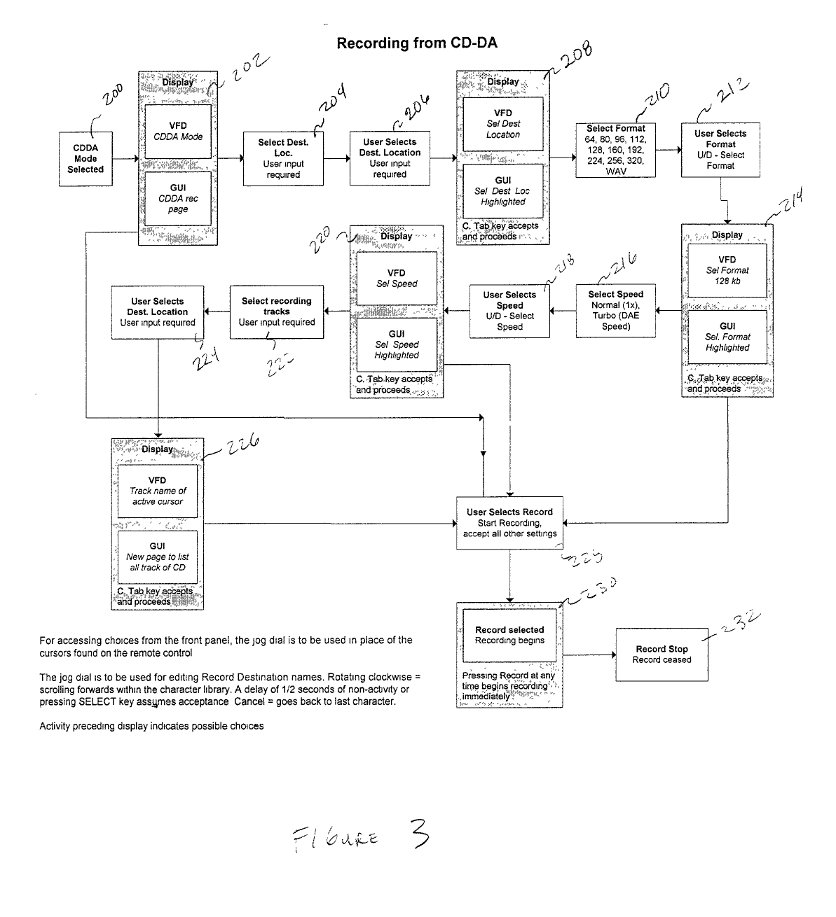

When required, the user may perform a conversion (recording) process from an external connected device or locally, from the CD-ROM drive. The former may be any device capable of CDDA playback or MP3 playback, connected to the appropriate socket found on the front or the rear of the system. When connected to an USB-equipped device, the process that takes place is in fact a file transfer in either direction between the system and the device. FIG. 3 describes the entire procedure required for successfully performing this operation.

To perform a recording from a known source, as described above, the user has to invoke the Record Mode page first. This may be done by either using the Record Mode hotkey found on a remote control or by toggling a Function key on the front panel. The various choices/selections available for recording are presented on a Graphical User Interface (GUI). The Vacuum Fluorescent Display (VFD) displays an appropriate message for each option set found on the GUI. In this case, it displays Record Mode truncated as needed, to fit the 7-segment VFD panel (for examples of VFD display types, see Table 1 below). After a time delay, the VFD refreshes itself to display the first option set.

TABLE 1
VFD display examples

| Option Set | Example 1 | Example 2 | Example 3 |
|---|---|---|---|
| Record Mode | RECMOdE | REC Md | RECORdM |
| Source | SOURCE | SRC | SRCE |
| Destination | dEST | dSTN | |
| Format | FORMAT | FORM | FMT |
| Destination | dESTLOC | dSTNLOC | dEST L |
| Location | | | |
| Speed | SPEEd | SPd | |

The various selections of recordings in this embodiment are:

From CD-DA disc;

From MP3 CD;

From Line-in;

CD Recorder;

USB MP3 portable devices; and

USB DSC devices.

When the recording mode is selected, the first point of entry is the CD-DA option 200. The user may scroll through the list of options using the up/down arrow key on the remote control or rotating the front panel's jog dial clockwise. In block 202, to confirm the selection of the appropriate choice, the user has to highlight the desired option followed by, either:

Cancel—to reject the current choice and return to previous set;

Right arrow key/Select key—to accept the current choice and continue to the following set; or

Record—to accept the current choice and begin recording immediately.

1.1 From CD-DA disc

In block 204, a default destination location/folder name is suggested by the system to store the ripped data in the HDD. In block 206, the user can choose to change the location name by entering text either through the remote control or the jog dial on the front panel in block 208. To key in text using the remote control, the relation between the alphabetical characters and the various numbers is illustrated below. In the current embodiment, the user is required to enter the desired character according to the set layout.

Next, the user is presented with the option to select from a number of different compression rates (bit-rates) to be used during the MP3 conversion process in block 210. The user may also choose to ignore the compression entirely and have the track to be recorded in a WAV format. Once a selection is made in block 212, pressing the “Cursor Tab” key skips to the next option set as displayed in block 214.

The last option set in the sequence provides the user with two choices of performing the recording in block 216. The first option allows the user to encode the desired tracks in real-time while simultaneously listening to the source. This should not be confused with the monitoring of a typical recording process where the destination is listened to instead of the source, in this case. The second option in the set is to perform the recording at the maximum possible speed, as determined by the DAE of the CD-ROM. This option runs in the background of the system in this embodiment; therefore, the user is not able to listen to the tracks being recorded. Block 218 symbolizes the user selecting the speed.

Throughout the set-up of the recording process, the VFD on the front panel of the system, as illustrated by block 220, provides the user with adequate information regarding the current option set, the choice made by the user, and any other necessary information. Due to the limited space available on the VFD in this embodiment, the messages are scrolled across the display.

Once all the set-up is done, the user has an option to see the listing of all tracks in the CD as illustrated in block 222. The user is allowed to select a few tracks or all tracks to be ripped from the CD as illustrated in block 224 and displayed in block 226. The user then hits the record button to start the recording process as illustrated in block 228 and displayed in block 230. When maximum ripping speed is chosen, a progress bar will indicate the state of ripping.

Once the recording has ended, or the input device has ceased playback, or the system has received a Stop Recording command, the system ceases the recording as illustrated in block 232 and returns to the idle state.

1.2 From MP3 CD

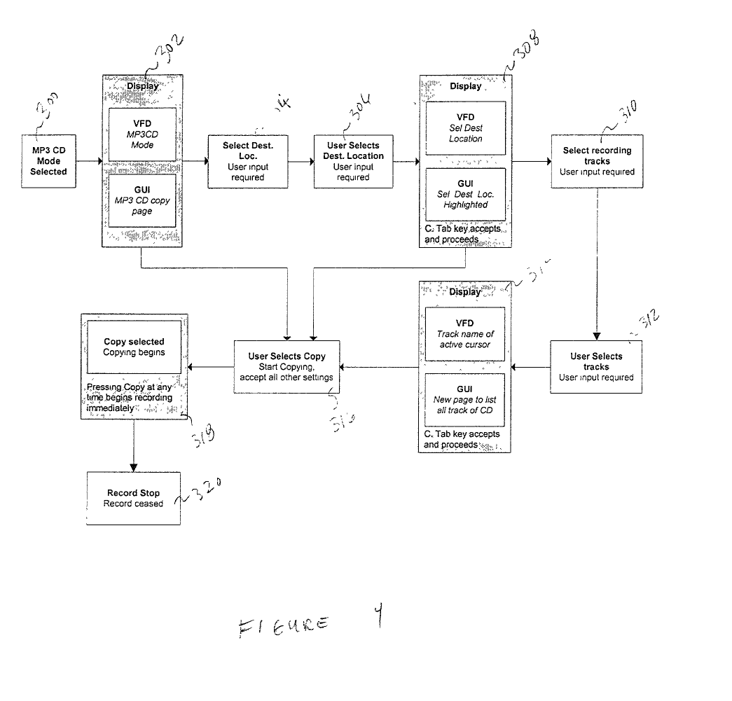

Now referring to FIG. 4, after the MP3 CD mode is selected in block 300 and displayed in block 302, a default destination location/folder name is suggested by the system in block 304 to store the ripped data in the HDD. The user can choose to change the location name by entering text either through the remote control or the jog dial on the front panel as illustrated in block 306 and displayed in block 308. To key in text using the remote control, the relation between the alphabetical characters and the various numbers is illustrated above. The user is required to enter the desired character according to the set layout.

After selecting the destination location, the user selects the tracks to be copied into the HDD in blocks 310 and 312 and displayed in block 314. When the copy process starts in block 316, a progress bar indicates the copying process as displayed in block 318. Block 320 illustrates the recording has stopped.

1.3 From Line-in

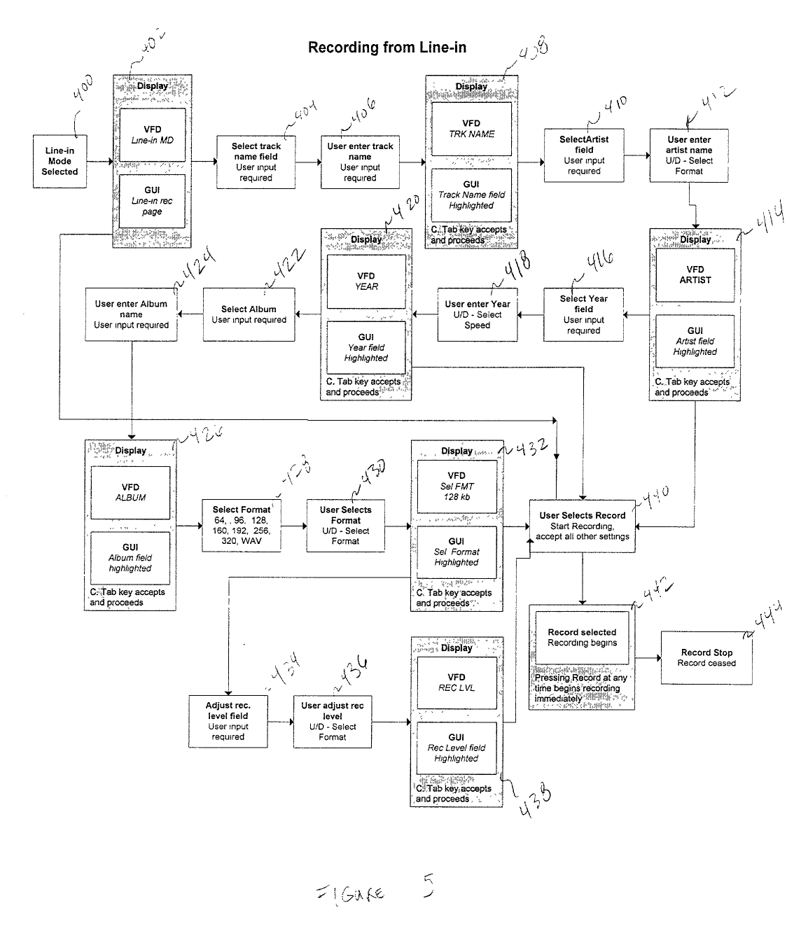

Now referring to FIG. 5, upon entering into the line-in recording GUI in blocks 400 and 402, the user can key in any pertinent information before the recording starts (e.g. track name, blocks 404, 406 and 408; artist, blocks 410, 412 and 414; year of production, blocks 416, 418 and 420; and album name, blocks 422, 424 and 426 ). However, default names are also available for the user. The user can also select the quality of recording by adjusting the compression rate as illustrated in blocks 428, 430 and 432. With the help of a volume slider, the user can adjust the recording volume of the line-in audio as illustrated in blocks 434 and 436 (note: upon entering the line-in mode, the user is able to monitor the audio from the line-in jack if the source is playing). There is a level indicator in block 438 to assist the user in judging the appropriate record volume. When the user is ready, the source starts playing while the iJB starts recording simultaneously as illustrated in blocks 440 and 442. To end the recording, the user stops the recording on the iJB first as illustrated in block 444.

1.4 USB MP3 portables devices

This mode is selected when the user wants to download MP3 files from iJB to a portable MP3 devices. Upon selecting this option, a list of MP3 portable devices that are supported by the current version of software is shown. The user selects the appropriate model that matches his device. The following options are available in the current embodiment:

establish connection;

clear memory;

select tracks to download; and

transfer file to MP3 device.

1.5 USB Digital still images transfer

This mode is selected when the user wants to transfer digital images from a USB based Digital Still Camera (“DSC”) to the iJB. Upon selecting this option, a list of USB DSC devices that are supported by current version of software is shown. The user selects the appropriate model that matches the DSC device from the list. The following options are available in the preferred embodiment:

establish connection;

select destination folder;

enter photo name; and

transfer file from DSC to iJB.

1.6 CD Recorder (MiCaR)

When this mode is selected, the following functions are available in the current embodiment:

transfer MP3 songs to MiCaR to be cut into an MP3 CD; and

control of MiCaR for MP3 CD recording.

1.7 Text Editing Example

If the destination location is, “The Corrs”, in this embodiment, the user is required to key in the characters in the following manner. Recall that the VFD is to display the information as required although, given the circumstances, it may display only the required characters. The actual entry of the text is set to a default upper case setting, however, it should be noted that toggling of the case is also allowed. This means that if the monitor were unavailable during a text entry process, the case of the character would be practically invisible to the user until the monitor is switched.

| T | h | e | [space] | C | o | r | r | s |
|---|---|---|---|---|---|---|---|---|
| 8 | 4-4 | 3-3, | 0, | 2-2-2 | 6-6-6 | 7-7-7 | 7-7-7 | 7-7-7-7 |

See Table 2 below for a list of the available characters and their respective numeric assignments.

TABLE 2
Character Assignments

| Number | Character | Number | Character | Number | Character |
|---|---|---|---|---|---|
| 1 | Etc. | 5 | J,K,L | 9 | W,X,Y,Z |
| 2 | A,B,C | 6 | M,N,O | 0 | Etc. |
| 3 | D,E,F | 7 | P,Q,R,S | * | Toggle |
| | | | | | Library |
| 4 | G,H,I | 8 | T,U,V | # | Case |
| | | | | | Switch |

As an alternative to the remote control, the jog dial may also be used for text entry. To do this, the user would simply rotate the jog dial clockwise to scroll through the library of characters and numbers (in ascending order, characters first, followed by numbers) and the remaining characters. The speed of the scrolling is dependent on the speed of rotation of the jog dial. To select the desired character and proceed to the next, the user may either press the Select key or wait for the end of a specified time-delay.

It should be noted that, by default, the destination location would be assigned the CD name (if the system has a connection to the music server and the disc to be copied has an entry in that server). If the source device is external to the system, then the user is allowed to provide the name. Otherwise, a default is provided. The user is also allowed to amend the location name as desired. The maximum length of the string, whether assigned or amended, is restricted to 128 characters in the current embodiment.

The following table illustrates some exemplary options that can be implemented in the current embodiment.

TABLE 3
Option set description

| Option Set | Choice | Description |
|---|---|---|
| Source | Analog Input | Provides for an analog connection to |
| | (Front) | a suitable device. The connection is |
| | | located on within the front panel of |
| | | the system. |
| | Analog Input | Provides for an analog connection to |
| | (Rear) | a suitable device. Connection may be |
| | | found at the rear of the system. |
| | USB (Front) | For the connection to an USB- |
| | | equipped device for either uploading |
| | | of MP3 data. The USB port may be |
| | | found on the front panel of the |
| | | system. |
| | USB (Rear) | For the connection to an USB- |
| | | equipped device for either uploading |
| | | of MP3 data. The USB port may be |
| | | found on the rear of the system. |
| | CD-ROM | For converting CDDA data into an |
| | | equivalent MP3 file at the selected |
| | | compression bit-rate. |
| Destination | USB (Front) | For downloading MP3 compressed |
| | | files into a suitable device for |
| | | portability or file transfer between |
| | | devices. Connection is provided |
| | | within the front panel of the system. |
| | USB (Rear) | For downloading MP3 compressed |
| | | files into a suitable device for |
| | | portability or file transfer between |
| | | devices. Connection is provided at |
| | | the rear of the system. |
| | Local Hard Disk | The primary storage device for |
| | | archiving MP3 compressed files. |
| Format | 64 kbps, 96 kbps, | User-selectable MP3 conversion |
| | 128 kbps, 160 kbps, | bit-rates. Size of final MP3 |
| | 192 kbps, 256 kbps, | compressed file is proportionate to |
| | 320 kbps, WAV | bit-rate and audio quality. WAV files |
| | | are similar to CDDA as no |
| | | compression is performed. |
| Destination | User input required | User is required to enter a name for |
| Location | | the destination location. If no entry is |
| | | detected, a default name will be |
| | | assigned. |
| Speed | Normal (DAE-1x) | Allows the recording operation to be |
| | | performed in real-time. This results in |
| | | the user being able to listen to the |
| | | song while it is being encoded. |
| | Turbo (Max. DAE | Compresses the file at the maximum |
| | speed) | speed set by the DAE. This setting |
| | | disables any audio output. |

2. Creating and Editing Playlists

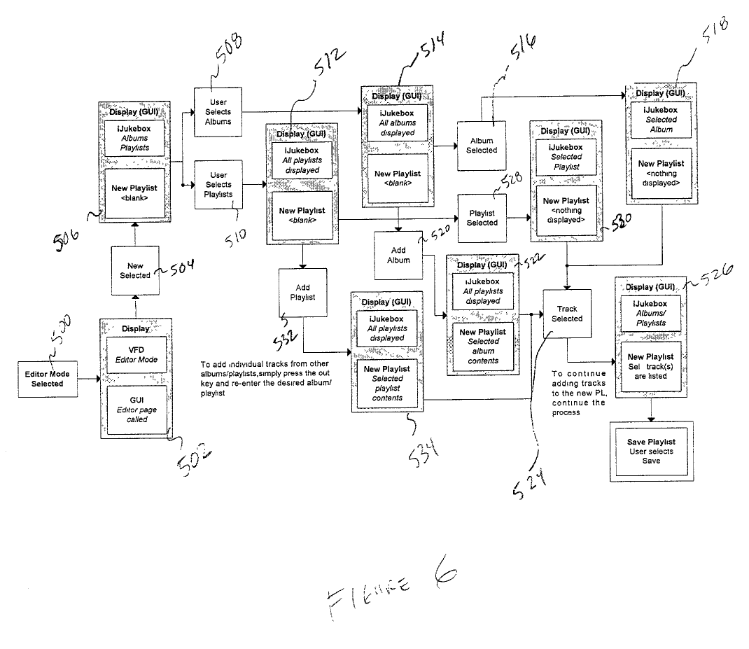

Now referring to FIG. 6, creating and editing playlists will be discussed. Playlists are the equivalent to programs available with most CD players. This feature allows the user to create lists of tracks according to various requirements (e.g. tempo, moods, genre, etc.).

Note that playlists are created within the Editor window. The user may access this window by using any of the following methods in the current embodiment:

Pressing the Editor hotkey found on the remote control; or

Pressing the Function key on the front panel of the system the required number of times until Editor appears on the VFD.

When selected, the Editor Mode window will appear on the GU as illustrated in blocks 500 and 502. Now referring to blocks 504 and 506, the first iJB window located at the top half of the monitor contains the options “All Songs”, “Albums”, and “Playlists” by default. The lower window (default—New Playlist) is empty, assuming a new playlist to be created. At this point, when New is selected, the onscreen GUI remains unchanged.

Creating A New Playlist

To create a new playlist, the user has to select the New option from the Editor window (as illustrated in block 504 ). This results in two windows being displayed on the GUI, one iJB above the other (New Playlist) (block 506 ). The iJB window displays the options “All Songs”, “Albums” and “Playlists” while New Playlist remains blank. The user may choose to include whole albums (block 508 ), whole playlists (block 510 ) or individual tracks from either. In blocks 512 and 514, to view the contents of either album or playlist, the user has to highlight the desired title and then select the In key (or the right arrow key) to enter. For this example, the In key (or the right cursor on the remote control) shall be used to enter the next lower level of the hierarchy and the Out key (or the left cursor on the remote control shall perform the reverse. Tracks from CDs are disallowed from being included in playlists.

As an example, assume that Albums is selected, the contents of the iJB window will then be replaced by a list of all available albums contained within the system as illustrated in blocks 516 and 518. To place an entire album into the playlist, the desired album must be highlighted and the Select key then pressed as illustrated in block 520. Once this is done, the contents of the selected album will then appear in the New Playlist window as illustrated in block 522. An additional block is required to place individual tracks. The user is required to press the right arrow on the remote control or the In key found on the GUI as illustrated in block 524. The iJB window then displays all the tracks available in the album. The user then has to select the desired tracks and then press the Select key to place individual songs into the playlist as illustrated in block 526.

Whole playlists may also be inserted into other playlists. To do so, as illustrated in blocks 528 and 530 simply follow the procedure described above for placing albums. All else is the same for placing tracks from playlists. Additionally, adding playlists is a similar procedure as illustrated in blocks 532 and 534. It should be noted that when creating playlists, the tracks stored by the albums and playlists are only links to the actual track and that although multiple links may exist, the track is not multiplied across the playlists or albums that contains it.

When the creation of the playlist is complete, the user is to press the Save key, as illustrated in block 536, whereupon a separate window appears allowing the user to further customize the playlist before finally saving the playlist. The options available in this embodiment are “Title”, “Year”, “Genre”, “Mood ” and “Popularity”. Once all the settings have been done, the user is then required to press Save to save the playlist. The newly created playlist then appears in its appropriate order in the albums section of the iJB window.

Editing Tracks/Albums/Playlists

To delete whole albums or playlists, or individual tracks, the user must first call on the Editor Mode window. The user must then call up the desired album, playlist or track using the method described above. Once the album/playlist is selected, all the tracks currently stored within are displayed in the New Playlist window. Tracks/Playlists/Albums are then added to or deleted from the current playlist as necessary, all of which appear in the lower window. To add/delete an album/playlist, the desired selection must first be highlighted in the upper window and then, the Select/Delete key pressed as necessary. To add/delete tracks, the user must select the In key on the appropriate album (highlighted as necessary) and then highlight the track. Pressing the Delete key then deletes the track from the album/playlist. If a deletion of a track or album is to be carried out, the user will be prompted for confirmation first. Once all this is done, pressing the Save key as before will bring out a separate window for setting up the saving process and the user may edit the “Title”, “Mood”, and so on. When finished, the user may choose to either select Save (to replace the first playlist chosen with the current set-up), to Save As (to create a new playlist) or Cancel (and continue editing the playlist).

3. Playback

As a default, upon power up, the Browse mode appears on the GUI. This page provides an interface to the system so that the user may access the various functions available, like the front panel of a CD player. In this window, the user is offered the choice of a variety of available playback sources. The sources in this embodiment are either, or all of, the following: “CD-<CD TITLE>”, “All Songs”, “Audio Albums”, “Photo Albums”, “Playlists”.

During the power-up sequence, the system initiates a disc-detection process to search the CD-ROM for the presence of valid media. If detected, and if the system is connected to a music server, the system begins querying the CDDB server for relevant information relating to the CD for download. If none is detected, the system continues with the initialization process and load the first playlist in the hierarchy as default.

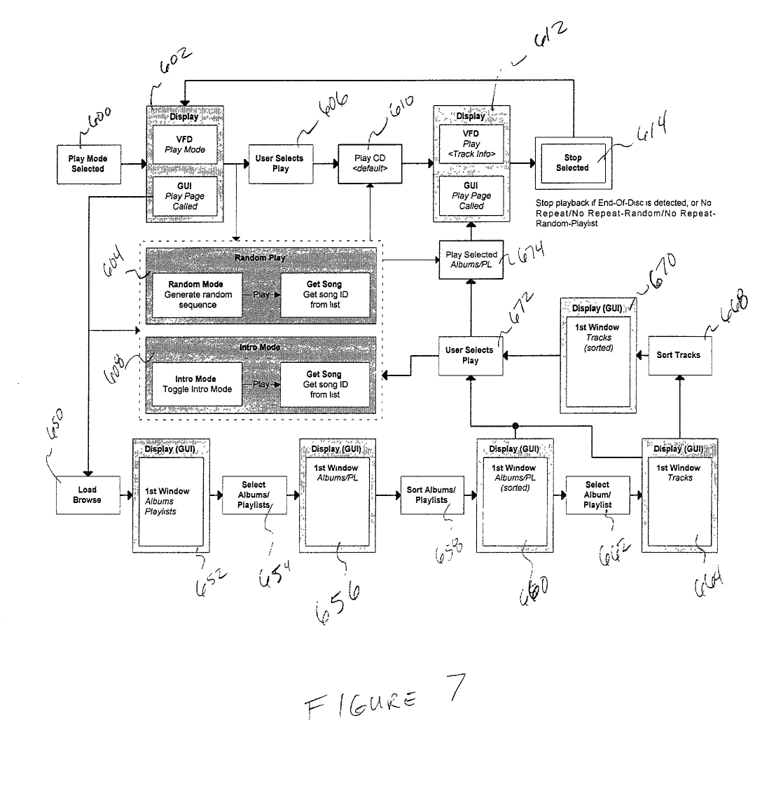

Now referring to FIG. 7, once the user has made a selection for playback, pressing the Play key on either the remote control or the front panel launches the playback process as illustrated in block 600. This results in the Play Mode Page being displayed on the GUI to display the relevant data and the VFD is also expected to provide useable and appropriate information regarding timing and text information to the user as illustrated by block 602. At any point in the playback process, the user enables the functions, Random (block 604), Sequential (block 606) and Repeat (not shown), but not the Intro function (block 608), which is usually only called while the system is in the idle mode.

After the user selects Play in block 606, the default CD is played in block 610 and displayed in block 612. Playback ends when the end of the disc, album, playlist or the all songs selection is reached while the Repeat function is disabled, or if the user issues a Stop command in block 614. Otherwise, the process continues indefinitely. When playback ceases, it returns to the Play Mode Page (block 602).

While in this page, the user may then choose to load another playlist or a stored album or so on for playback. To do this, as illustrated by block 650, the user needs only to select the Browse button on the GUI, which brings up a window displaying first the Albums and the Playlists options for selecting either to load an album or a playlist as illustrated by block 652.

Browse Function

Within the Play Mode window, the user may choose the Browse function to view all the available playlists stored in the system. When called, this function produces a window that displays all the available albums and playlists in the system for selection by the user (blocks 654 and 656). The contents of each playlist are also available for viewing by toggling the In key so that the contents are displayed in the window. Within this window, the user may also perform the following functions:

Search—to search for a particular track or album according to predefined criteria (not shown); and

Sort—to sort the list of tracks/albums/playlists according to the criteria: Title, Year, Genre, Mood and Popularity as set previously during the creation/editing of album/playlist as shown in blocks 658 and 660. Once the albums/playlists are sorted, the sorted albums/playlists can be selected as shown in block 662. The tracks also then shown in block 664. The user may then sort the tracks as shown in blocks 668 and 670, or directly select play as shown in block 672. Depending on whether the random feature is enabled, the a random sequence is generated before playing (block 674). Once playback starts, the procedure then proceeds to block 612 and the process can start over.

Photo View

When Photo Album is selected, all the available albums are listed for the user. The following options are available in the current embodiment:

auto slideshow; and

manual viewing.

Auto slideshow

The user is also able to set the time interval between each photo image. After the preset, all photo images in the select photo album are displayed one at a time for the pre-determined time set by the user. When all the photos have been viewed, it will return to the album selection page.

Manual viewing

In this mode, the user manually selects the photo through the arrows and select button on the remote control.

4. System/Set-up

Most of the information and setting of the iJB can be accessed from this tab. Below are the list of options that are available in the current embodiment:

system information

date/time setting

TV mode

Scan disk

Disk defragmentation

Software update

4.1 System information

The following information is available to the user in the current embodiment:

HDD free space in MB;

HDD free space in %;

Total number of songs in the system;

Total number of Artists in the system;

Total number of Albums in the system;

Numbers of CD pending for CDDB information;

Numbers of CD with active CDDB information;

Software version; and

Hardware version.

4.2 Date/time setting

Due to the various time zones throughout the different geographical regions, there is a need for a user to set-up the local date and time in order for an appropriate database synchronization between the Music Server and the iJB.

4.3 TV mode

In order to accommodate different types of TVs, the user has a choice to select between the PAL and NTSC video output formats.

4.4 Disk Defragmentation

After a pro-longed period of usage on the iJB, it may be necessary to defragment the HDD due to deleting or organizing of files. The disk defragmentation tool helps to arrange the files to optimize the performance of the system.

4.5 Software update

From time to time, there may be a new version of software release to enhance the performance or to add new features to the system. Through a software update option, users can get an updated version from the Music Server and perform an upgrade of the system automatically.

5 Power down sequence

Users are not restricted from power down from any means. It can be down by the power standby key which puts the system into standby mode or by a switch to directly turn off the AC power. Although it is preferred to power down the system from a standby mode rather than directly from AC power, a recovery system is in place for the next time the user powers the system on again.

5.1 Power down while encoding

In the case of fast ripping of CD data to HDD, encoding to MP3 format is done on background. Two exemplary scenarios follow:

Scenario 1—during background encoding, user selected power off to standby mode, system should prompt user that encoding will continue to complete all un-finish work and shutdown when all job is done. During this period, TV output will be cut and left with only VFD to show the status; and

Scenario 2—during background encoding, the user switches off AC power. The system is able to keep a record of which tracks have not been encoded and will resume the background encoding the next time the iJB is power on.

6. StoreX array

The StoreX array is the storage expansion unit used in conjunction with the iJB. It provides an upgrade path for the user of iJB to store as many songs and photo in the iJB unit without worrying about storage space. Features of the StoreX in the current embodiment are:

30 to 120 GB of storage per array box;

built in local file management;

daisy chain connection to provide unlimited boxes to be connected;

virtually no limitation of expansion; and

plug and play.

### Examples

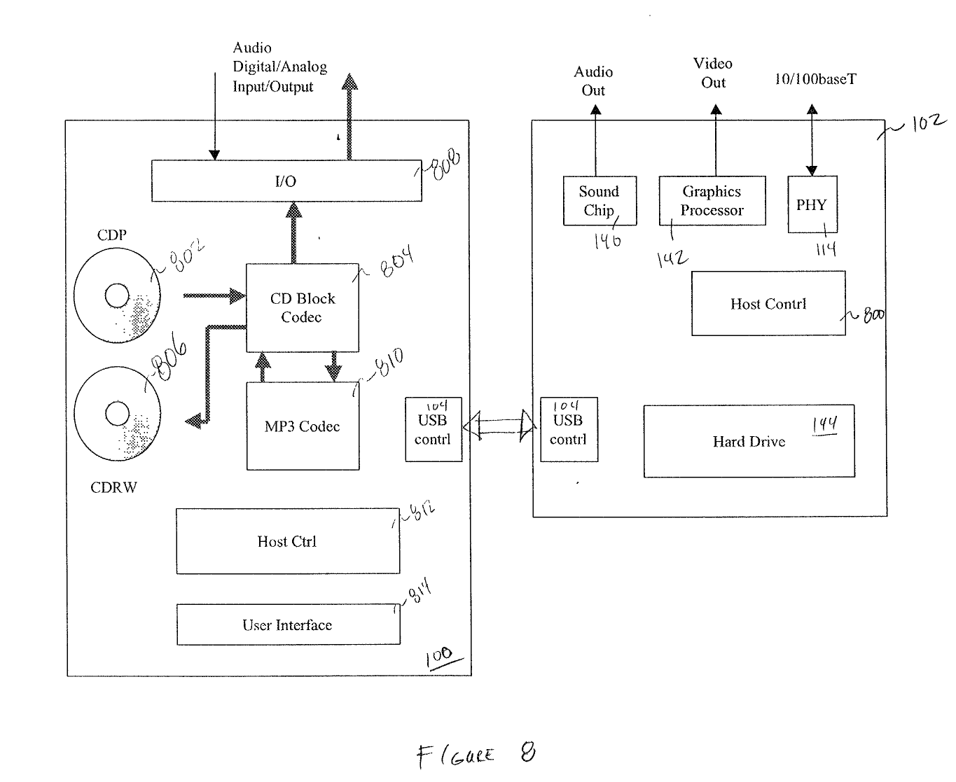

FIG. 8 illustrates the communication path for a CD to CD recording, a CD to MP3 CD recording, a MP3 CD to MP3 CD recording and a MP3 CD to CD recording. The CD to CD recording includes playing the CD 802 which passes the signal to the CD block CODEC 804 that then writes the signal onto the CD RW device 806. Additionally, the signal from the CD Player 802 can be heard by sending the signal out the I/O module 808 through the Audio Digital/Analog outputs.

Similarly the CD to MP3 CD recording goes through the same process but gets encoded through the MP3 CODEC 810 first. The recordings for MP3 CD to MP3 CD and the MP3 CD to CD also proceed similar to the previous sequence.

Also depicted in FIG. 8 are the host controller 812 and the user interface within the CD Recorder 100 and the host controller 800 within the iJB 102.

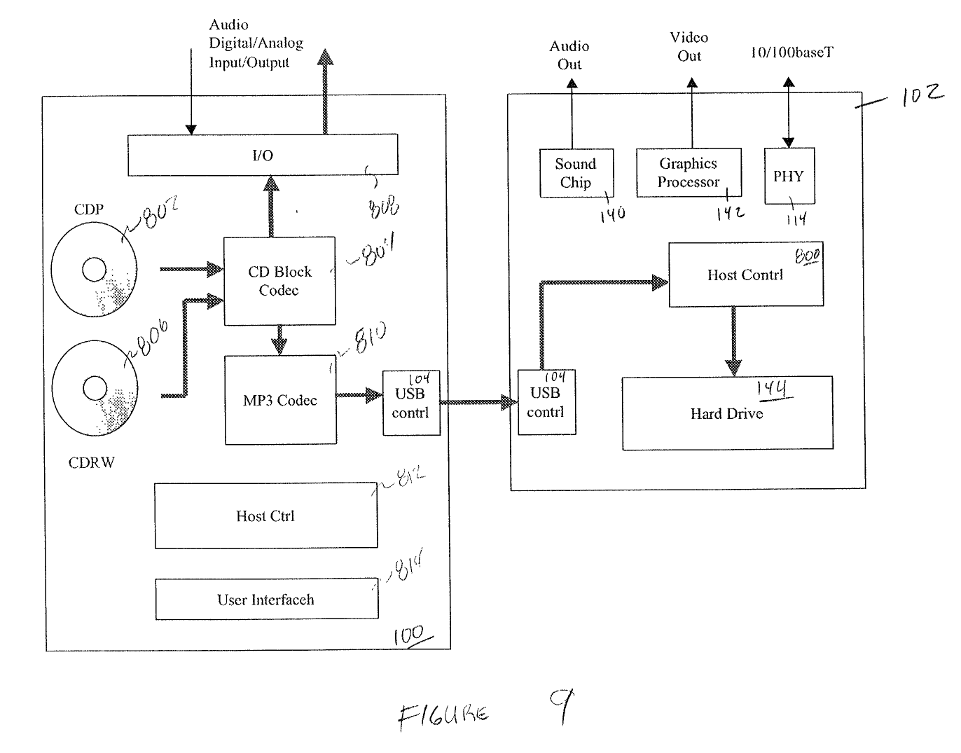

FIG. 9 depicts a CD to MP3 to iJB recording as well as a MP3 to iJB recording. The recordings start with either the CD Player 802 or the CD RW device 806 playing and sending the signal into the CD Block CODEC 804, and if playing, into the I/O module 808. The MP3 CODEC also either decodes, or encodes the signal, depending on if it is from a MP3 signal or to a MP3 signal, respectively. The signal then gets transferred to the iJB 102 through the USB 104 into the Hard drive 144 by the iJB Host controller 800.

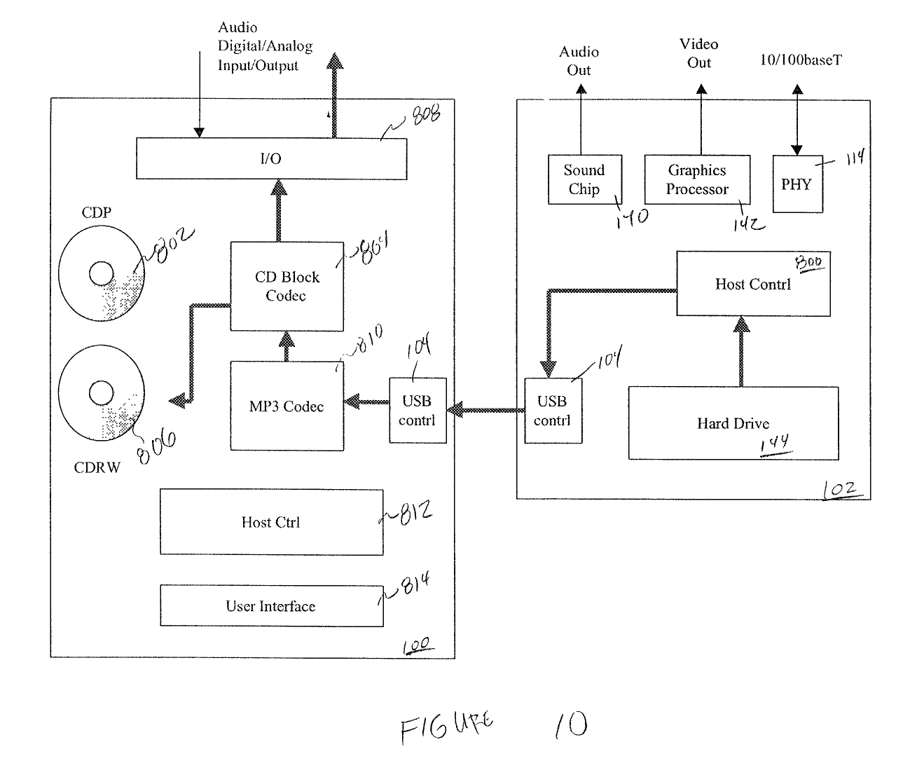

Conversely, FIG. 10 depicts a iJB to MP3 CD or to a CD-DA recording. The MP3 signal first is transferred from the Hard Drive 144 through the USB 104 by the iJB host controller 800 into the CD Recorder 100. The signal first goes through the MP3 CODEC 810 into the CD Block CODEC 804 and gets written on the CD RW 806.

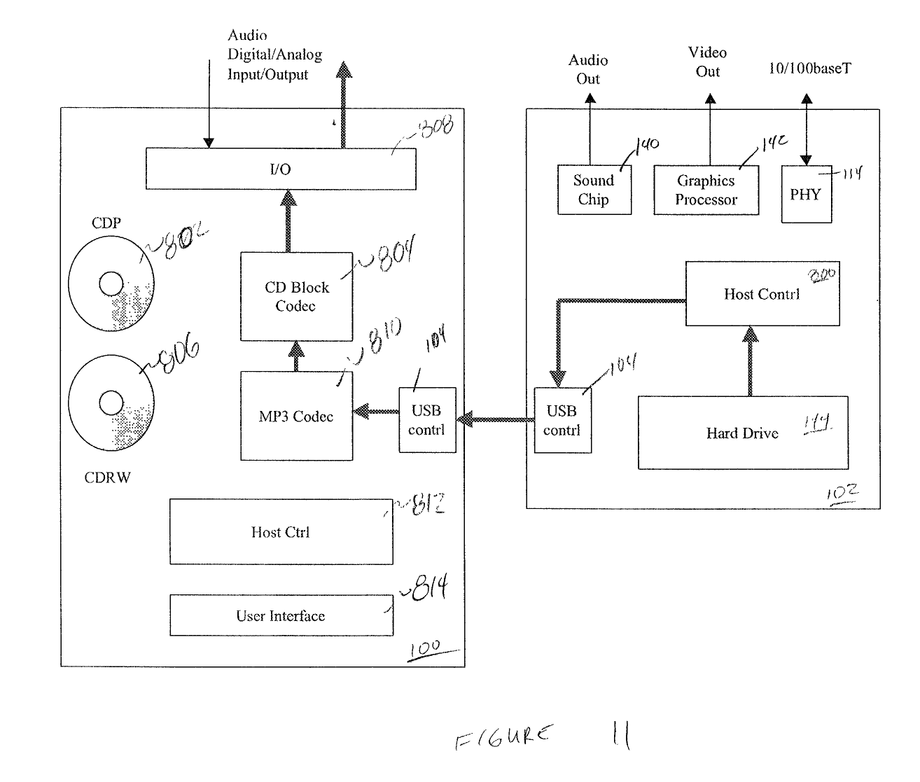

FIG. 11 depicts one method playing music from the iJB 102. The signals follow the same path as the previous example, except that instead of getting recorded on the CD-RW 806, the CD Block CODEC 804 just sends the signals to the I/O module 808 and out the Digital/Analog outputs.

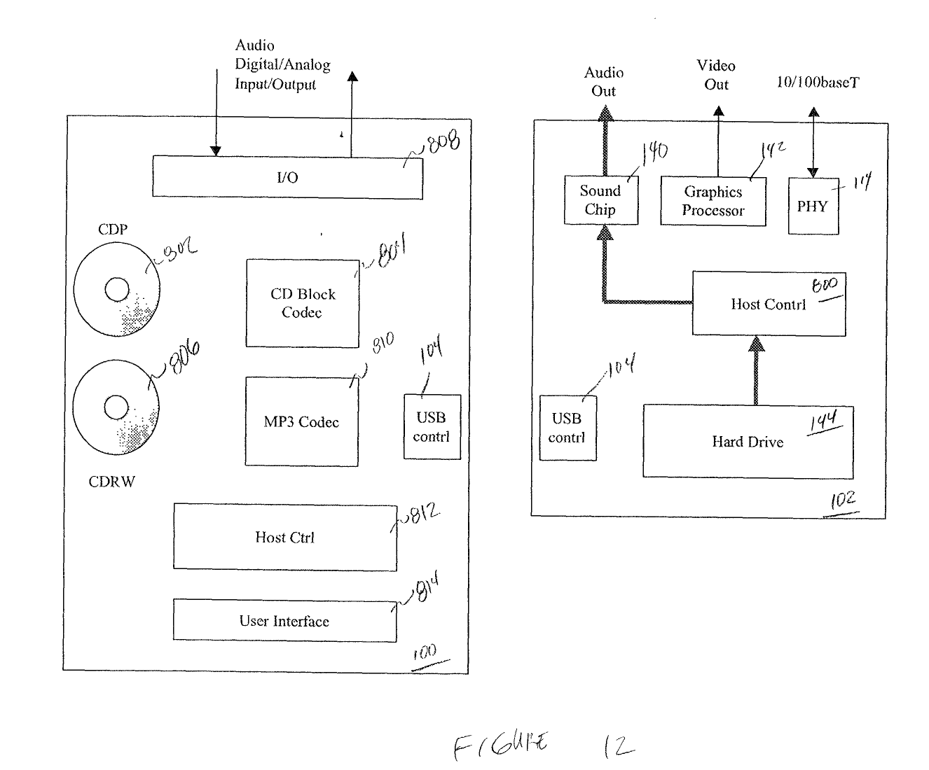

FIG. 12 depicts another method of playing music from iJB 102. The signal gets transferred from the Hard Drive 144 to the sound chip 140 by the host controller 800.

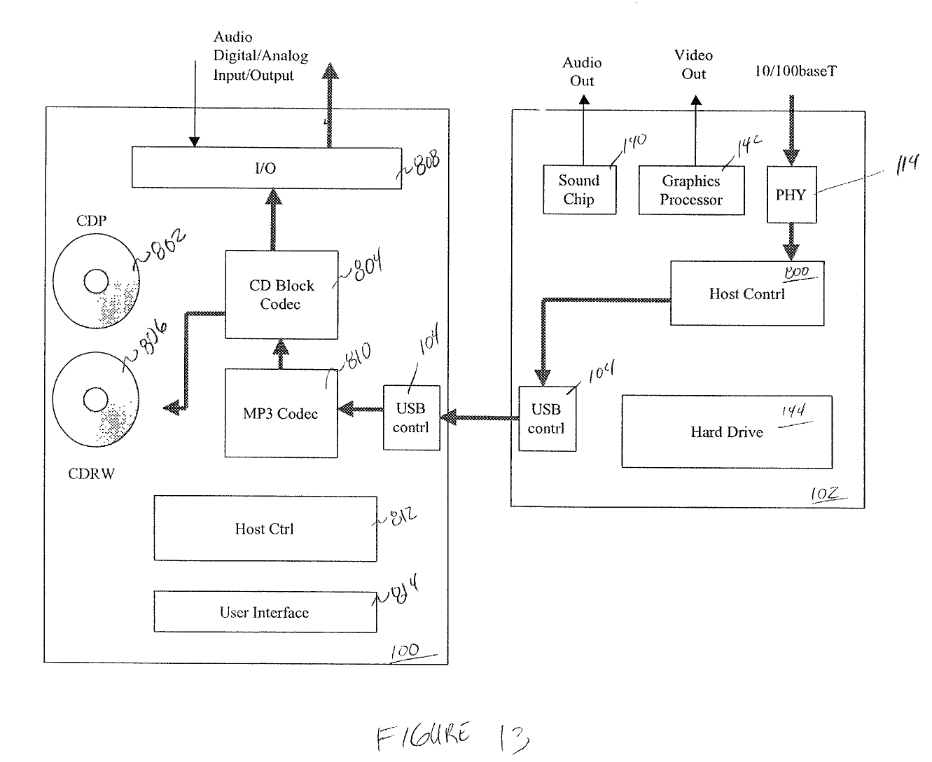

FIG. 13 depicts a remote download of music files to record on MP3 CD or a CD-DA. The files first go through the Ethernet connection 114 and to the MP3 CODEC 810 and the CD Block CODEC 804. Then the files would get written on the CDRW 806. However, if the recording was for MP3 files and the source files were not already encoded, the MP3 CODEC 810 would first encode the files before writing them. Additionally, if the user wanted to hear the music files, the files would be also sent to the I/O module 808 to be played.

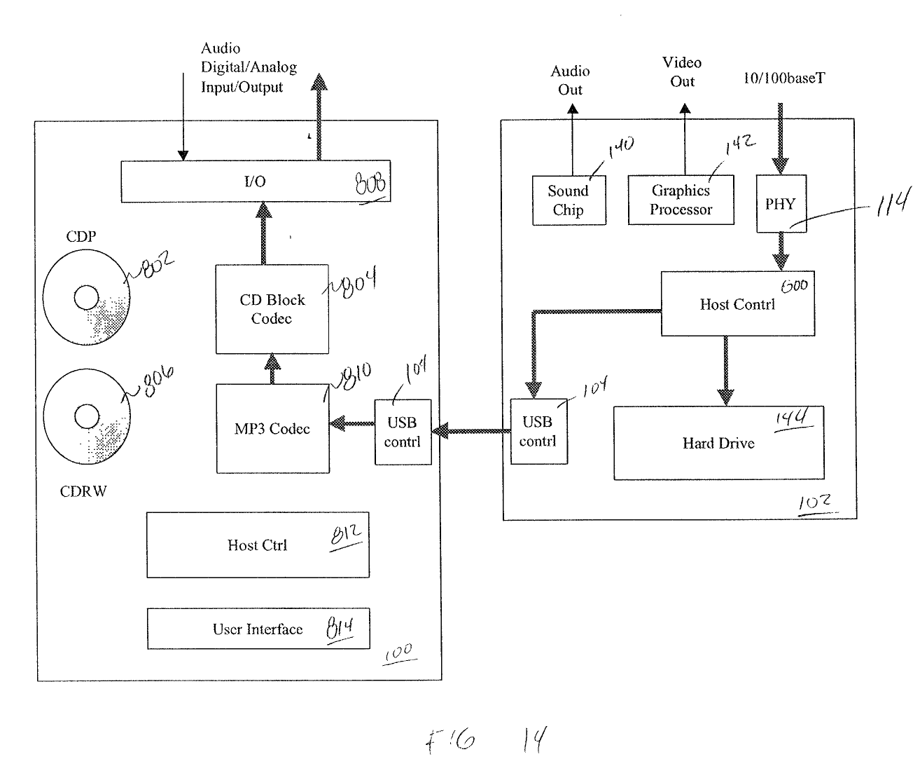

FIG. 14 depicts another remote download of music files, except the files only get recorded on the Hard disk drive 144 and then get played out by the CD Recorder 100.

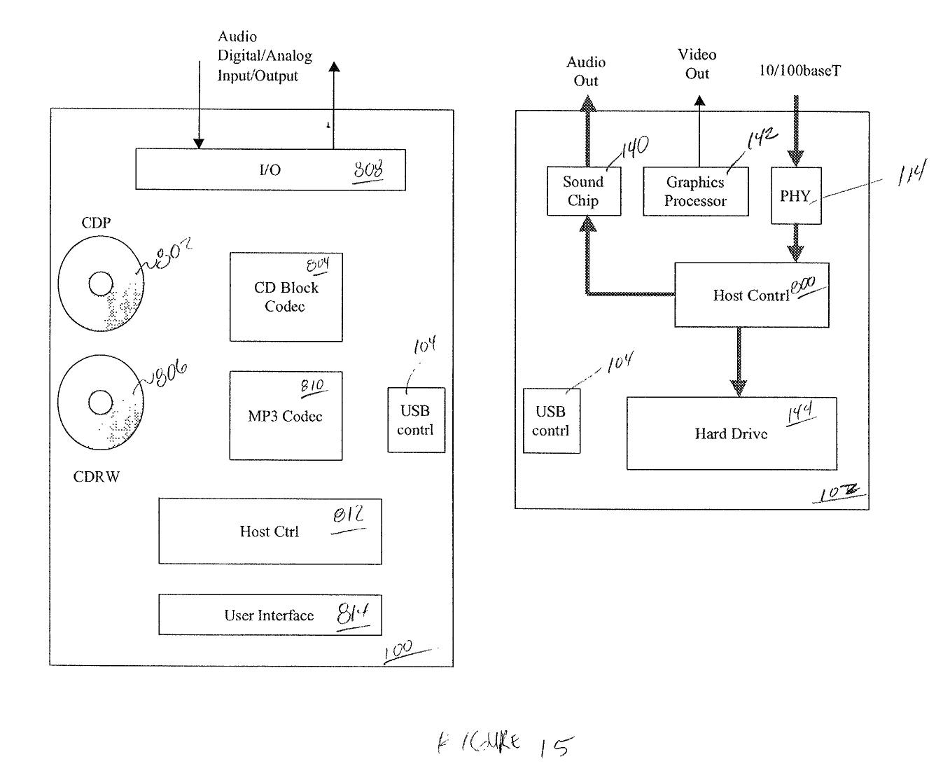

FIG. 15 depicts another remote download of music files similarly to FIG. 14, except that the music files are played out of the sound chip 140 on the iJB 102.

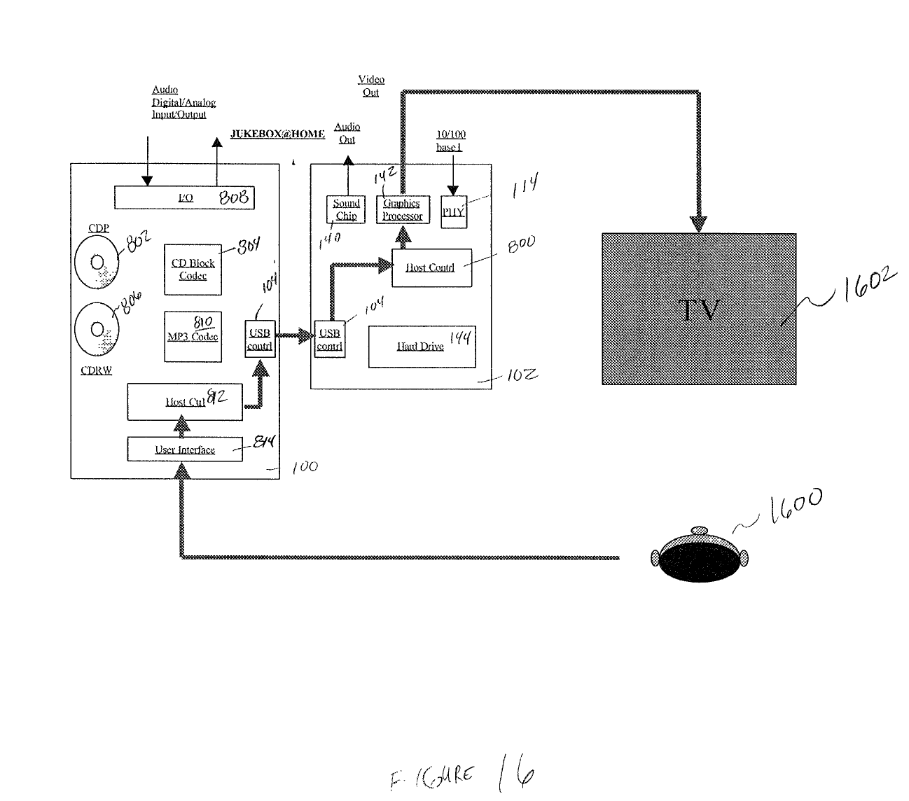

FIG. 16 depicts a user 1600 interfacing with the CD Recorder 100 through the user interface 814 and into the iJB 102 with the use of a TV 1602 as the display.

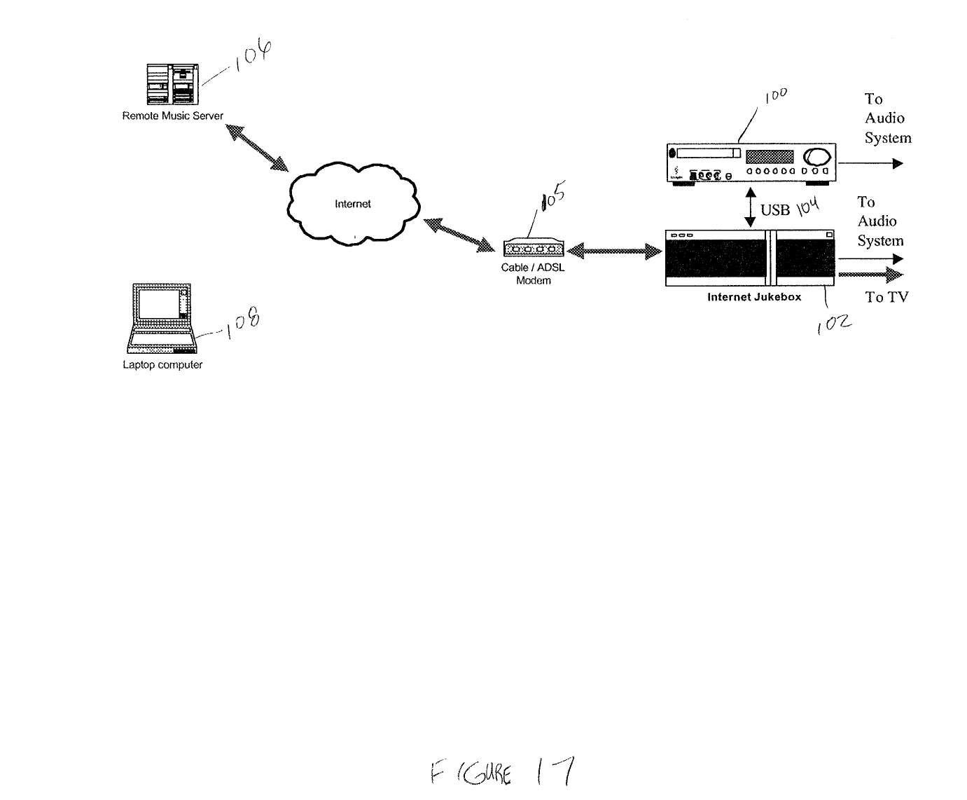

FIG. 17 depicts how the iJB 102 can connect to a Remote Music Server 106. Upon power up, the iJB 102 registers with the Remote Music Server 106 by negotiating for a dynamic IP from an ISP (not shown) through the Cable/ADSL modem 105. The iJB 102 then homes in aon the remote music server's 106 fixed IP address. It 102 then registers with the remote music server 106. The server 106 then prompts the iJB 102 to update the internal software if there are any updates.

Moreover, the iJB 102 can synchronize with the Remote Music Server 106 by getting a CD's unique ID after loading the CD into the CD Recorder 100. The music server 106 then informs the matched disc information and track tags for the iJB 102 to display and to transfer to the CD Recorder 100.

Additionally, the iJB 102 streams audio by first selecting streaming audio by the remote control, then requesting the audio from the music server 106. The music server 106 then streams the compressed audio to the iJB 102. The iJB then decodes the audio and outputs the audio, or passes it on to the CD Recorder 100 to be decoded.

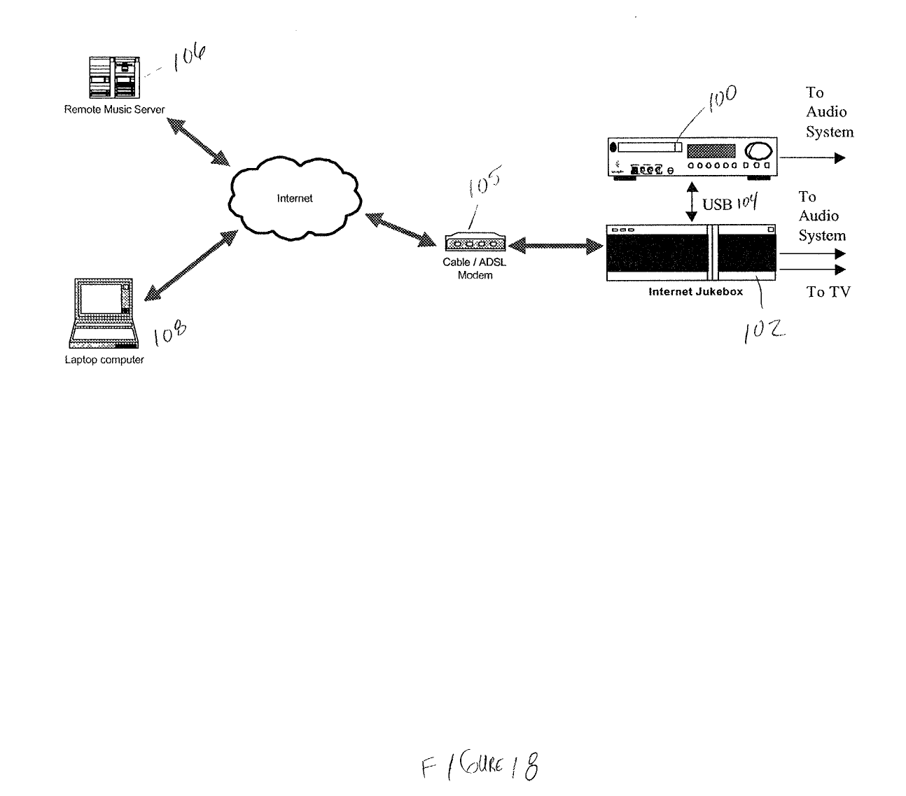

FIG. 18 depicts how a user can remotely access and/or manage the iJB 102. The user first accesses the remote music server 106. The server 106 then synchronizes with the iJB 102 and displays the iJB's 102 music content directories and related information in HTML format. The user can then manage the iJB information with a web browser to manipulate the information and/or playback the files.

It is understood that several modifications, changes and substitutions are intended in the foregoing disclosure and in some instances some features of the invention will be employed without a corresponding use of other features. Accordingly, it is appropriate that the appended claims be construed broadly and in a manner consistent with the scope of the invention.

1. A method for providing access to and management of multimedia files on a plurality of storage devices, the method comprising:
storing a plurality of multimedia files on at least one of the plurality of storage devices;
providing access for a user to the plurality of multimedia files;
means for encoding and decoding compressed multimedia files; and
means for playing the plurality of multimedia files.
